(19) United States
(12) Patent Application Publication
(10) Pub. No.: US 2025/0238619 A1
(43) Pub. Date: Jul. 24, 2025

(54) TRAINING ENTITY RECOGNITION MODEL

(71) Applicant: Tencent Technology (Shenzhen) Company Limited, Shenzhen (CN)

(72) Inventors: Jie ZHOU, Shenzhen (CN); Le TIAN, Shenzhen (CN); Xiao ZHOU, Shenzhen (CN)

(73) Assignee: Tencent Technology (Shenzhen) Company Limited, Shenzhen (CN)

(21) Appl. No.: 19/173,666

(22) Filed: Apr. 8, 2025

Related U.S. Application Data
(63) Continuation of application No. PCT/CN2023/131436, filed on Nov. 14, 2023.

(30) Foreign Application Priority Data
Feb. 2, 2023 (CN) 202310101696.6

(51) Int. Cl. G06F 40/295; G06N 20/00

(52) U.S. Cl. CPC G06F 40/295; G06N 20/00

(57) ABSTRACT

In a method for training an entity recognition model, sample text data including entity text content is acquired. Entity recognition is performed on the sample text data using a candidate entity recognition model to obtain an entity recognition result corresponding to the sample text data. A recognition loss value is determined based on a difference between the entity division label and the entity recognition result. A sample quality score corresponding to the sample text data is acquired. Loss adjustment is performed on the recognition loss value based on the sample quality score to obtain a predicted loss value. The candidate entity recognition model is trained based on the predicted loss value to obtain a trained entity recognition model that is configured to perform entity recognition on inputted text data. Apparatus and non-transitory computer-readable storage medium counterparts are also contemplated.

### RELATED APPLICATIONS

The present application is a continuation of International Application No. PCT/CN2023/131436, filed on Nov. 14, 2023, which claims priority to Chinese Patent Application No. 202310101696.6, filed on Feb. 2, 2023. The entire disclosures of the prior applications are hereby incorporated by reference.

### FIELD OF THE TECHNOLOGY

This application relates to the field of information extraction, including a method for training an entity recognition model.

### BACKGROUND OF THE DISCLOSURE

Entity recognition is an information extraction technology, also referred to as named entity recognition (NER), and refers to recognition of a semantic entity with a specific meaning in a query word. The entity recognition is usually configured for acquiring entity data such as a person name and a place name from text data, and is a very important and basic issue in natural language processing.

In related art, to more robustly train a model, a large amount of sample data is usually acquired to perform a model training process. When there is less labeled sample data, discrete text may be converted into a vector sequence by using a pretrained language model and another word embedding manner. Then, based on multi-way recall and knowledge dictionaries, labels are corrected based on a difference between entity phrases, to implement a process of labeling a large amount of unlabeled data, expand a data quantity of sample data, and further train the model by using the data as weakly supervised data, thereby improving a model training effect.

In the foregoing method, although model training is performed by using the large amount of sample data, the process of labeling unlabeled data strongly relies on label content corresponding to data introduced by the multi-way recall and the knowledge dictionaries, that is, relies on labeling the unlabeled data through data augmentation, causing a large amount of noise data to be easily introduced. The training process is performed based on sample data with poor accuracy, resulting in low efficiency of training an entity recognition model, and also affecting accuracy of entity recognition performed by the entity recognition model.

### SUMMARY

Aspects of this disclosure provide a method for training an entity recognition model, an apparatus, and a non-transitory computer-readable storage medium so that a trained entity recognition model can perform entity recognition on inputted text data. Technical solutions include the following:

An aspect of this disclosure provides a method for training an entity recognition model. Sample text data including entity text content is acquired. The sample text data is labelled with an entity division label that represents a distribution of the entity text content in the sample text data. Entity recognition is performed on the sample text data using a candidate entity recognition model to obtain an entity recognition result corresponding to the sample text data. A recognition loss value is determined based on a difference between the entity division label and the entity recognition result. A sample quality score corresponding to the sample text data is acquired. The sample quality score represents a loss weight that corresponds to the recognition loss value. Loss adjustment is performed on the recognition loss value based on the sample quality score to obtain a predicted loss value. The candidate entity recognition model is trained based on the predicted loss value to obtain a trained entity recognition model that is configured to perform entity recognition on inputted text data.

An aspect of this disclosure provides an information processing apparatus. The information processing apparatus includes processing circuitry configured to acquire sample text data including entity text content. The sample text data is labelled with an entity division label that represents a distribution of the entity text content in the sample text data. The processing circuitry is configured to perform entity recognition on the sample text data using a candidate entity recognition model to obtain an entity recognition result corresponding to the sample text data. The processing circuitry is configured to determine a recognition loss value based on a difference between the entity division label and the entity recognition result. The processing circuitry is configured to acquire a sample quality score corresponding to the sample text data. The sample quality score represents a loss weight that corresponds to the recognition loss value. The processing circuitry is configured to perform loss adjustment on the recognition loss value based on the sample quality score to obtain a predicted loss value. The processing circuitry is configured to train the candidate entity recognition model based on the predicted loss value to obtain a trained entity recognition model that is configured to perform entity recognition on inputted text data.

An aspect of this disclosure provides a non-transitory computer-readable storage medium storing instructions which when executed by a processor cause the processor to perform any of the methods of this disclosure.

The technical solutions provided in this disclosure can include the following beneficial effects:

Entity recognition is performed on acquired sample text data by using a candidate entity recognition model, to obtain an entity recognition result corresponding to the sample text data; a recognition loss value is determined based on a difference between an entity division label and the entity recognition result; a sample quality score corresponding to the sample text data is acquired, and loss adjustment is performed on the recognition loss value based on the sample quality score, to obtain a predicted loss value; and the candidate entity recognition model is trained by using the adjusted predicted loss value, to obtain an entity recognition model. In addition, when noise data is not introduced into sample text data obtained through additional labeling, a loss weight corresponding to the recognition loss value is learned based on the sample quality score determined for the sample text data, so that differential loss adjustment is performed on the candidate entity recognition model based on recognition loss values respectively corresponding to sample text data with different sample quality scores. In this way, limited sample text data that has been labeled can be fully used to more robustly train the candidate entity recognition model, thereby greatly reducing impact of the noise data on the entity recognition result, and improving efficiency of training the entity recognition model and accuracy of entity recognition.

### BRIEF DESCRIPTION OF THE DRAWINGS

FIG. 1 is a schematic diagram of an implementation environment according to an aspect of this disclosure.

FIG. 2 is a flowchart of a method for training an entity recognition model according to an aspect of this disclosure.

FIG. 3 is a flowchart of a method for acquiring a predicted loss value according to an aspect of this disclosure.

FIG. 4 is a flowchart of a method for acquiring a quality scoring model according to an aspect of this disclosure.

FIG. 5 is a schematic diagram of a framework for training an entity recognition model according to an aspect of this disclosure.

FIG. 6 is a flowchart of a method for acquiring sample text data according to an aspect of this disclosure.

FIG. 7 is a schematic diagram of dictionary-based data expansion according to an aspect of this disclosure.

FIG. 8 is a schematic diagram of text prompt-based pretrained language model data expansion according to an aspect of this disclosure.

FIG. 9 is a schematic diagram of multi-model recall-based data expansion according to an aspect of this disclosure.

FIG. 10 is a structural block diagram of an apparatus for training an entity recognition model according to an aspect of this disclosure.

FIG. 11 is a structural block diagram of an apparatus module for training an entity recognition model according to an aspect of this disclosure.

FIG. 12 is a structural block diagram of a terminal according to an aspect of this disclosure.

### DETAILED DESCRIPTION

Descriptions of terms in this disclosure are provided as examples only and are not intended to limit the scope of the disclosure.

Entity recognition is an information extraction technology, also referred to as named entity recognition, and refers to recognition of a semantic entity with a specific meaning in a query word. The entity recognition is usually configured for acquiring entity data such as a person name and a place name from text data, and is a very important and basic issue in natural language processing. In the related art, to more robustly train a model, a large amount of sample data is usually acquired to perform a model training process. When there is less labeled sample data, discrete text may be converted into a vector sequence by using a pretrained language model and another word embedding manner. Then, based on multi-way recall and knowledge dictionaries, labels are corrected based on a difference between entity phrases, to implement a process of labeling a large amount of unlabeled data, expand a data quantity of sample data, and further train the model by using the data as weakly supervised data, thereby improving a model training effect.

According to a method for training an entity recognition model provided in the aspects of this disclosure, entity recognition is performed on acquired sample text data by using a candidate entity recognition model, to obtain an entity recognition result corresponding to the sample text data; a recognition loss value is determined based on a difference between an entity division label and the entity recognition result; a sample quality score corresponding to the sample text data is acquired, and loss adjustment is performed on the recognition loss value based on the sample quality score, to obtain a predicted loss value; and the candidate entity recognition model is trained by using the adjusted predicted loss value, to obtain an entity recognition model. In addition, when noise data is not introduced into sample text data obtained through additional labeling, a loss weight corresponding to the recognition loss value is learned based on the sample quality score determined for the sample text data, so that differential loss adjustment is performed on the candidate entity recognition model based on recognition loss values respectively corresponding to sample text data with different sample quality scores. In this way, limited sample text data that has been labeled can be fully used to more robustly train the candidate entity recognition model, thereby greatly reducing impact of the noise data on the entity recognition result, and improving efficiency of training the entity recognition model and accuracy of entity recognition.

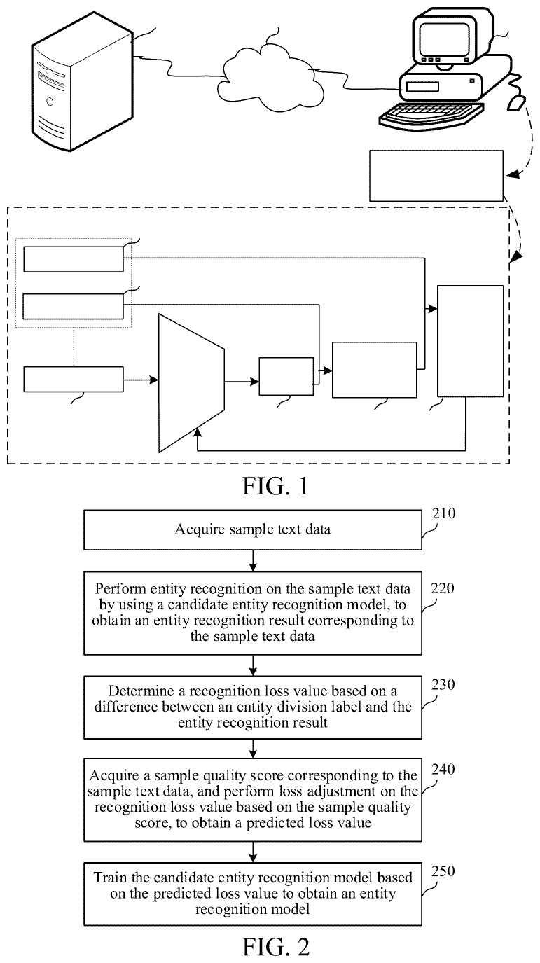

First, an example of an implementation environment in this disclosure is introduced. FIG. 1 is a schematic diagram of an implementation environment according to an aspect of this disclosure. The implementation environment includes a terminal 110.

A candidate entity recognition model 111 is deployed in the terminal 110. Sample text data 101 is stored in the terminal 110. The terminal 110 acquires the sample text data 101, where the sample text data 101 is labelled with an entity division label 103 configured for representing distribution of entity text content in the sample text data 101. Entity recognition is performed on the sample text data 101 by using the candidate entity recognition model 111, to obtain a corresponding entity recognition result 102. The candidate entity recognition model 111 is configured to perform entity recognition on the inputted sample text data 101, and the outputted entity recognition result 102 is configured for representing distribution of the entity text content in the sample text data 101 predicted by the candidate entity recognition model 111. A recognition loss value 105 is determined based on a difference between the entity recognition result 102 and the entity division label 103 corresponding to the sample text data 101. A sample quality score 104 corresponding to the sample text data 101 is acquired, where the sample quality score 104 is configured for representing a loss weight corresponding to the recognition loss value 105. Loss adjustment is performed on the recognition loss value 105 based on the sample quality score 104, to obtain a corresponding predicted loss value 106. The candidate entity recognition model 111 is trained based on the predicted loss value 106, to obtain an entity recognition model.

In some aspects, the implementation environment further includes a server 120 and a communication network 130. The server 120 stores the sample text data 101, the corresponding entity division label 103, and the corresponding sample quality score 104. The terminal 110 acquires the sample text data 101, the corresponding entity division label 103, and the corresponding sample quality score 104 from the server 120 through the communication network 130, to train the candidate entity recognition model deployed in the terminal 110 to obtain the entity recognition model.

The foregoing terminal may be an example. The terminal may be terminal devices in a plurality of forms such as a desktop computer, a portable laptop computer, a mobile phone, a tablet computer, an e-book reader, a moving picture experts group audio layer III (MP3) player, a moving picture experts group audio layer IV (MP4) player, a smart television, and a smart vehicle. This is not limited in the aspects of this disclosure.

The foregoing server may be an independent physical server, or may be a server cluster or a distributed system formed by a plurality of physical servers, or may be a cloud server that provides basic cloud computing services such as a cloud service, cloud security, a cloud database, cloud computing, a cloud function, cloud storage, a network service, cloud communication, a middleware service, a domain name service, a security service, a content delivery network (CDN), big data, and an artificial intelligence platform.

The cloud technology is a hosting technology that unifies a series of resources such as hardware, software, and networks in a wide area network or a local area network to implement computing, storage, processing, and sharing of data.

In some aspects, the foregoing server may alternatively be implemented as a node in a blockchain system.

To further describe, according to this disclosure, a prompt interface or a pop-up window may be displayed, or voice prompt information may be outputted before and during collecting user-related data (for example: account information, historical operation data, and real-time operation data involved in this disclosure). The prompt interface, the pop-up window, or the voice prompt information is configured for prompting the user that data related to the user is currently being collected, so that this disclosure only starts to perform related steps of acquiring the user-related data after acquiring a confirmation operation of the user for the prompt interface or the pop-up window, otherwise (that is, when the confirmation operation of the user for the prompt interface or the pop-up window is not acquired), ends the related steps of acquiring the user-related data, that is, skips acquiring the user-related data. In other words, all user data collected by this disclosure is collected with the consent and authorization of the user, and the collection, use, and processing of user-related data need to comply with relevant laws, regulations, and standards of relevant regions.

For example, FIG. 2 is a flowchart of a method for training an entity recognition model according to an aspect of this disclosure. The method may be applicable to a terminal, a server, or both a terminal and a server. This aspect of this disclosure is described by using an example in which the method is applicable to the terminal. As shown in FIG. 2, the method includes the following operations.

Operation 210: Acquire sample text data. For example, sample text data including entity text content is acquired. The sample text data is labelled with an entity division label that represents a distribution of the entity text content in the sample text data.

The sample text data includes entity text content, the sample text data is labeled with an entity division label, and the entity division label is configured for representing distribution of the entity text content in the sample text data.

In some aspects, the sample text data is a natural language text segment labelled with the entity division label. The entity text content is text content configured for representing a specific object, and has specific meanings, including a person name, a place name, an organization name, a proper noun, and the like. The entity division label is configured for representing boundary information, that is, a relative position, of the entity text content in the sample text data, and an entity type corresponding to the entity text content, where the boundary information includes a beginning, an end, a middle of a sentence, and the like, and the entity type includes entity types in various fields such as film and television, sports, education, and art, such as an actor name, a film and television name, a stadium name, and a school name.

For example, the sample text data is implemented as text “In recent days, a film and television B in which an actor A starred is very popular”, where the entity division label is configured for labelling that the “actor A” and the “film and television B” are entity text content, and labelling that an entity type corresponding to the “actor A” is an actor name and an entity type corresponding to the “film and television B” is a film and television name.

In some aspects, a manner of acquiring the sample text data includes at least one of acquiring the sample text data from a preset text database, or performing text data expansion based on text data in a text database.

For example, data is extracted in various manners from a specified public text data set as sample text data; or entity text content in existing text data is replaced when a semantic condition is met, and non-entity text content in the existing text data is synonymously replaced, to obtain sample text data. For example, in existing text data “In recent days, a film and television B in which an actor A acted is very popular”, entity text content “actor A” and “film and television B” are replaced; and in non-entity text content, “acted” is synonymously replaced with “participated”, and “in recent days” is synonymously replaced with “recently”, to obtain sample text data “Recently, a film and television D in which an actor C participated is very popular”, where the “actor A” and the “film and television B” meet an acting relationship, and the “actor C” and the “film and television D” meet a participation relationship. In other words, the foregoing replacement meets the semantic condition.

Operation 220: Perform entity recognition on the sample text data by using a candidate entity recognition model, to obtain an entity recognition result corresponding to the sample text data. For example, entity recognition is performed on the sample text data using a candidate entity recognition model to obtain an entity recognition result corresponding to the sample text data.

In some aspects, the entity recognition result is configured for representing distribution of the entity text content in the sample text data predicted by the candidate entity recognition model. For example, sample text data “Xiaohong is the best employee of Tengyun Company” is inputted into the candidate entity recognition model for entity recognition, and an outputted entity recognition result includes: “Xiaohong” is an entity, of which an entity type is a person name; “Tengyun Company” is an entity, of which an entity type is a company name; “best employee” is an entity, of which an entity type is a title name; and boundary information of the foregoing entities in the sample text data is labeled.

Operation 230: Determine a recognition loss value based on a difference between an entity division label and the entity recognition result. For example, a recognition loss value is determined based on a difference between the entity division label and the entity recognition result.

In some aspects, the entity division label is a pre-labeled label that can represent actual distribution of the entity text content in the sample text data. The entity recognition result is a result predicted by the candidate entity recognition model and can represent predicted distribution of the entity text content in the sample text data. A difference between the entity division label and the entity recognition result is configured for representing accuracy of prediction of the candidate entity recognition model. In some aspects, a larger difference between the entity division label and the entity recognition result indicates that a corresponding recognition loss value is larger.

Operation 240: Acquire a sample quality score corresponding to the sample text data, and perform loss adjustment on the recognition loss value based on the sample quality score, to obtain a predicted loss value. For example, a sample quality score corresponding to the sample text data is acquired. The sample quality score represents a loss weight that corresponds to the recognition loss value. In an example, loss adjustment is performed on the recognition loss value based on the sample quality score to obtain a predicted loss value.

The sample quality score is configured for representing a loss weight corresponding to the recognition loss value.

In some aspects, a manner of acquiring the sample quality score includes at least one of the following manners:

In a first manner, the sample quality score is a preset quality score corresponding to the sample text data, and the corresponding sample quality score is acquired when the sample text data is acquired.

In a second manner, quality scoring is performed on the sample text data by using a preset quality scoring model, to obtain the corresponding sample quality score.

In a third manner, the sample quality score is acquired by using a preset quality score table, and the quality score table includes a correspondence between the sample text data and the sample quality score.

In some aspects, the sample quality score represents data quality of the sample text data. For example, a higher sample quality score indicates that data quality of the sample text data is better, that is, noise of the sample text data is smaller. In this way, when loss adjustment is performed on the recognition loss value based on the sample quality score, the loss weight of the sample text data is smaller, so that a training effect of the candidate entity recognition model based on the obtained predicted loss value can be improved.

Operation 250: Train the candidate entity recognition model based on the predicted loss value to obtain an entity recognition model. For example, the candidate entity recognition model is trained based on the predicted loss value to obtain a trained entity recognition model that is configured to perform entity recognition on inputted text data.

The entity recognition model is configured to perform entity recognition on inputted text data.

In some aspects, the candidate entity recognition model is trained based on the predicted loss value until a training requirement is met, to obtain the entity recognition model. In some aspects, the training requirement includes at least one of a predicted loss value converging or a predicted loss value reaching a specified threshold.

The foregoing content describes content of training the candidate entity recognition model to obtain the entity recognition model. The recognition loss value is adjusted to obtain the predicted loss value that can more represent the entire sample text data. The model is trained through reducing the predicted loss value, and a case that the predicted loss value converges or reaches a specified threshold is used as a reference basis for that the model training is completed. In this way, a degree of model training can be determined more intuitively, and the trained entity recognition model is further obtained in a more targeted manner.

In some aspects, after the entity recognition model is obtained, text data is acquired, the text data is inputted into the entity recognition model for entity recognition, and a corresponding entity recognition prediction result is outputted, where the entity recognition prediction result is configured for representing distribution of entity text content in the text data.

For example, a text segment is extracted in various manners from a specified text library as to-be-analyzed text data, for example, “Currently, a TV play X in which Xiaoming starred is very popular” is inputted into the entity recognition model for entity recognition, and distribution of entity text content “Xiaoming” and the “TV play X” in the text data is outputted, to represent that “Xiaoming” and the “TV play X” are entity text content, an entity type of “Xiaoming” is a person name, an entity type of the “TV play X” is a film and television name, and positions of “Xiaoming” and the “TV play X” in the text data are shown.

A process of analyzing the text data by using the entity recognition model is described in the foregoing content. The entity recognition model is a model trained based on the predicted loss value, and the predicted loss value is content obtained by performing loss constraint on the sample quality score of the sample text data. Therefore, the entity recognition model can acquire the entity content and the distribution of the entity content from the text data more accurately by using quality represented by the text data as a constraint, that is, obtain a more accurate entity recognition prediction result through prediction.

In summary, in the method provided in this aspect of this disclosure, entity recognition is performed on acquired sample text data by using a candidate entity recognition model, to obtain an entity recognition result corresponding to the sample text data; a recognition loss value is determined based on a difference between an entity division label and the entity recognition result; a sample quality score corresponding to the sample text data is acquired, and loss adjustment is performed on the recognition loss value based on the sample quality score, to obtain a predicted loss value; and the candidate entity recognition model is trained by using the adjusted predicted loss value, to obtain an entity recognition model. In addition, when noise data is not introduced into sample text data obtained through additional labeling, a loss weight corresponding to the recognition loss value is learned based on the sample quality score determined for the sample text data, so that differential loss adjustment is performed on the candidate entity recognition model based on recognition loss values respectively corresponding to sample text data with different sample quality scores. In this way, limited sample text data that has been labeled can be fully used to more robustly train the candidate entity recognition model, thereby greatly reducing impact of the noise data on the entity recognition result, and improving efficiency of training the entity recognition model and accuracy of entity recognition.

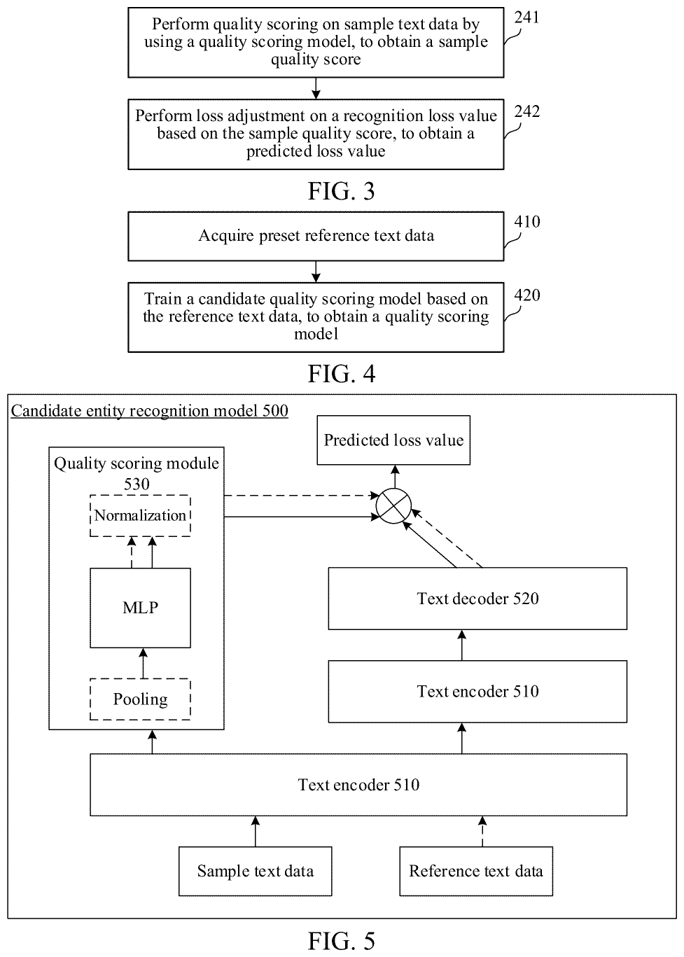

FIG. 3 is a flowchart of a method for acquiring a predicted loss value according to an aspect of this disclosure. As shown in FIG. 3, in some aspects, the foregoing operation 240 includes the following operations.

Operation 241: Perform quality scoring on the sample text data by using a quality scoring model, to obtain the sample quality score. For example, quality scoring is performed on the sample text data using a quality scoring model to obtain the sample quality score. The quality scoring model is configured to perform quality scoring on inputted text data.

In some aspects, the quality scoring model is a preset score model, or the quality scoring model is a score model obtained by training a preset candidate quality scoring model. In some aspects, the quality scoring model is implemented as a part of the entity recognition model, or is implemented as an independent score model.

For example, the sample quality score is implemented as a score of 0 to 1, the sample text data is inputted into the quality scoring model for quality score, and the sample quality score corresponding to the sample text data is outputted as a score of 1.

Operation 242: Perform loss adjustment on the recognition loss value based on the sample quality score, to obtain a predicted loss value. For example, loss adjustment is performed on the recognition loss value based on the sample quality score to obtain a predicted loss value.

In some aspects, the sample quality score represents data quality of the sample text data. For example, a higher sample quality score indicates that data quality of the sample text data is better, that is, noise of the sample text data is smaller. In this way, when loss adjustment is performed on the recognition loss value based on the sample quality score, the loss weight of the sample text data is smaller, so that a training effect of the candidate entity recognition model based on the obtained predicted loss value can be improved.

For example, when the candidate entity recognition model is trained by using a plurality of pieces of sample text data, recognition loss values and sample quality scores respectively corresponding to the plurality of pieces of sample text data are determined, and recognition loss values corresponding to the plurality of pieces of sample text data are adjusted based on the sample quality scores. Therefore, loss weights represented by the sample quality scores respectively corresponding to the plurality of pieces of sample text data are integrated, to perform differential training on the candidate entity recognition model, thereby improving a targeted training of the model.

The foregoing operation 241 and operation 242 describe content of performing loss adjustment on the recognition loss value by representing the sample quality score of the sample text data. The sample quality score is content related to the acquired sample text data, and can better represent overall nature of the sample text data. The quality scoring model obtaining through pretraining can more quickly analyze the sample text data, to obtain a more accurate and more efficient sample quality score. In addition, based on the loss weight represented by the sample text data represented by the sample quality score, differential loss adjustment is performed on recognition loss values respectively corresponding to different pieces of sample text data based on sample quality scores respectively corresponding to different pieces of sample text data, which is conducive to obtaining predicted loss values respectively corresponding to the sample text data. On the premise of reflecting the content of the model, differential training is performed on the model by using different pieces of sample text data, thereby improving the training effect of the model.

In some aspects, operation 242 is implemented as the following two operations.

Operation 1: Determine a loss weight corresponding to the recognition loss value based on the sample quality score.

In some aspects, a higher sample quality score indicates that a loss weight corresponding to the recognition loss value is larger.

In some aspects, the sample quality score is used as a weight parameter representing the loss weight of the recognition loss value, or a product of the sample quality score and a preset adjustment factor is used as a weight parameter representing the loss weight of the recognition loss value.

For example, a value range of the sample quality score is preset to a score of 0 to 1, the sample quality score is implemented as a score of 0.4, and 0.4 is used as the weight parameter of the loss weight representing the recognition loss value. The value range of the sample quality score is preset to a score of 0 to 100, and a product 0.9 of a value 90 of the sample quality score and a preset adjustment factor 0.01 is used as the weight parameter representing the loss weight of the recognition loss value.

Operation 2: Fuse the loss weight and the recognition loss value to obtain the predicted loss value.

In some aspects, fusing the loss weight and the recognition loss value is implemented as fusing the loss weight and the recognition loss value through a preset algorithm, for example, multiplying a weight parameter corresponding to the loss weight by the recognition loss value. In some aspects, the predicted loss value is implemented as a sum of a plurality of predicted loss values respectively corresponding to the plurality of pieces of sample text data. For example, a predicted loss value L is implemented as a sum of predicted loss values L1, L2, and L3 respectively corresponding to three pieces of sample text data A, B, and B. L1 is implemented as a product of a weight parameter a of a loss weight corresponding to sample text data A and a recognition loss value 11, L2 is implemented as a product of a weight parameter b of a loss weight corresponding to sample text data B and a recognition loss value L2, and L3 is implemented as a product of a weight parameter c of a loss weight corresponding to sample text data C and a recognition loss value L3. In other words, a calculation manner of the predicted loss value L is implemented as the following formula: L=L1+L2+L3=a*11+b*12+c*13

The foregoing content describes content of fusing the loss weight represented by the sample quality score and the recognition loss value to obtain the predicted loss value. The loss weight is a weight of the recognition loss value determined by using the sample quality score. A higher sample quality score indicates that sample text data represented by the sample quality score is better, and the recognition loss value obtained from the sample text data can provide a more accurate reference during model training. Therefore, a larger loss weight corresponds to the sample text data. Through a positive correlation between the sample quality score and the loss weight, differential training can be performed on the candidate entity recognition model based on different pieces of sample text data, thereby improving model robustness and prediction accuracy of the model.

In some aspects, before the foregoing operation 241, a process of acquiring a quality scoring model is further included. FIG. 4 is a flowchart of a method for acquiring a quality scoring model according to an aspect of this disclosure. As shown in FIG. 4, the process includes the following operations.

Operation 410: Acquire preset reference text data. For example, reference text data labelled with a reference score label is acquired. The reference score label represents a quality score that corresponds to the reference text data.

The reference text data is labelled with a reference score label, and the reference score label is configured for representing a quality score corresponding to the reference text data.

In some aspects, the preset reference text data is a text data set that has been manually verified, and the reference score label is configured for representing that data quality of the reference text data is high. For example, a score of 0 to 1 is used to represent a value range of a quality score. A higher score indicates that data quality is higher, and the reference score label of the reference text data represents that the quality score of the reference text data is 1.

Operation 420: Train a candidate quality scoring model based on the reference text data, to obtain the quality scoring model. For example, a candidate quality scoring model is trained based on the reference text data to obtain the quality scoring model.

In some aspects, the reference text data is configured for enabling the candidate quality scoring model to learn a quality scoring capability. In other words, text data that is more similar to entity distribution of the reference text data corresponds to a higher quality score.

The foregoing operation 410 and operation 420 describe content of training the candidate quality scoring model by using referring text data and a corresponding reference score label, to obtain the quality scoring model. The reference text data is labelled with the reference score label representing the quality score. A supervised training process can be performed on the model by using the reference score label, so that the quality scoring model can learn quality score content represented by the reference text data more accurately. A quality scoring model with a better analysis effect is obtained through a plurality of times of training, thereby improving model prediction accuracy of the quality scoring model. The sample text data can also be analyzed more rapidly by using the quality score, thereby improving efficiency of acquiring the sample quality score.

In some aspects, the foregoing operation 420 is implemented as the following three operations.

Operation 1: Perform quality scoring on the reference text data by using the candidate quality scoring model, to obtain a standard quality score corresponding to the reference text data.

For example, the reference text data is inputted into the candidate quality scoring model for quality score, and the standard quality score corresponding to the reference text data is outputted as 0.8.

Operation 2: Determine a quality score loss value based on a difference between the standard quality score and the reference score label.

For example, the quality score loss value is determined based on a difference between the standard quality score 0.8 and the reference score label 1.

In some aspects, a larger difference between the standard quality score and the reference score label indicates that a quality score loss value is larger, and otherwise indicates that a quality score loss value is smaller.

Operation 3: Train the candidate quality scoring model based on the quality score loss value to obtain the quality scoring model.

In some aspects, a model parameter of the candidate quality scoring model is adjusted based on the quality score loss value, and iterative training is performed on the candidate quality scoring model. A larger quality score loss value indicates that an adjustment amplitude of the model parameter is larger.

The foregoing content describes content of training the candidate quality scoring model by using the reference text data. quality scoring is performed on the reference text data by using the candidate quality scoring model, to obtain a predicted reference quality score, and then a score loss value for model training is acquired based on a difference between the reference quality score and a pre-labeled reference score label, and then the model is trained by using the score loss value, to obtain the quality scoring model. In this process, a supervised learning training is performed on the candidate quality scoring model by using the reference score label, which helps enable the trained quality scoring model to analyze the received text data more accurately. In this way, the sample quality score of the sample text data can be obtained more accurately by using the trained quality scoring model, to further improve accuracy of acquiring the predicted loss value by using the sample quality score.

In summary, in the method provided in the aspects of this disclosure, quality scoring is performed on the sample text data by using the quality scoring model, to obtain the sample quality score, and loss adjustment is performed on the recognition loss value based on the sample quality score, to obtain the predicted loss value. A method for acquiring the sample quality score is provided, and efficiency of acquiring the sample quality score is improved.

According to the method provided in the aspects of this disclosure, the loss weight corresponding to the recognition loss value is determined based on the sample quality score, and the loss weight and the recognition loss value are fused to obtain the predicted loss value. In this way, loss weights corresponding to sample text data with different qualities are adjusted based on the sample quality score, thereby reducing impact of noise data on the entity recognition result, and improving efficiency of training the entity recognition model and accuracy of entity recognition.

According to the method provided in the aspects of this disclosure, the preset reference text data is acquired, and the candidate quality scoring model is trained based on the reference text data, to obtain the quality scoring model. A method for acquiring the quality scoring model is provided, thereby improving efficiency of acquiring the sample quality score.

According to the method provided in the aspects of this disclosure, the quality scoring is performed on the reference text data by using the candidate quality scoring model, to obtain the standard quality score corresponding to the reference text data, the quality score loss value is determined based on the difference between the standard quality score and the reference score label, and the candidate quality scoring model is trained based on the quality score loss value, to obtain the quality scoring model. A method for training the quality scoring model is provided, so that the candidate quality scoring model can learn a quality scoring capability based on the reference text data, thereby improving efficiency and accuracy of the quality score.

For example, FIG. 5 is a schematic diagram of a framework for training an entity recognition model according to an aspect of this disclosure. As shown in FIG. 5, a candidate entity recognition model 500 includes a text encoder 510, a text decoder 520, and a quality scoring module 530. Sample text data and reference text data are inputted into the text encoder 510, the text encoder 510 outputs a corresponding text representation, and the text representation is inputted into the text decoder 520 to obtain a corresponding recognition result. Based on a difference between the recognition result and an entity division label, a recognition loss value is determined, the text representation is inputted into the quality scoring module 530 to obtain a corresponding quality score, and a corresponding recognition loss value is adjusted based on the quality score to obtain a predicted loss value.

In some aspects, the text encoder 510 is implemented as a pretrained language model (PLM), the text decoder 520 is implemented as a linear layer and a conditional random field (CRF) module, the quality scoring module 530 includes a multilayer perceptron (MLP), the text encoder 510 and the text decoder 520 are configured to perform an entity recognition task, the sample text data is implemented as an expanded data set A, and the reference text data is implemented as a clean subset C. It is assumed that the clean subset C has M samples, and the expanded data set A has N samples, M being less than N is presented in quantity. Each batch of clean data samples X_{c} in the clean subset C is inputted to a pretrained language model to acquire text representation of each sample x_{c}ⁱ as [h_{c}^{i,0}, . . . , h_{c}^{i,j}, . . . h_{c}^{i,n}]. Then, an intermediate representation after pooling is inputted into a quality discriminator MLP layer as an overall text representation, to obtain a score p_{c}ⁱ of each sample. A calculation formula of p_{c}ⁱ is as follows:

$${s}_{c}^{i} = tanh ( {W}_{p}^{T} {h}_{c}^{i , 0} + {b}_{p} ) ,$$

$${z}_{c}^{i} = {W}_{q}^{T} {s}_{c}^{i} + {b}_{q} , and$$

$${p}_{c}^{i} = \frac{1}{1 + {e}^{- {z}_{c}^{i}}} .$$

where C represents a quantity of clean data samples in each batch in the clean subset C, i represents a sequence number, x_{c}ⁱ is an i^{th} sample in X_{C}, h_{c}^{i,j} represents a (j+1)^{th} text representation of x_{c}ⁱ, s_{c}ⁱ is an intermediate representation after pooling of x_{c}ⁱ, z_{c}ⁱ is an implicit representation of s_{c}ⁱ obtained by inputting an MLP, p_{c}ⁱ is a score of x_{c}ⁱ, and Wₚ^{T}, bₚ, and b_{q} are preset parameters. A training objective of the clean data sample x_{c}ⁱ of the MLP is that a score of clean data is 1, a loss function of the MLP is L_{quality-c}, and a loss function in an entity recognition task is L_{NER-c}. Calculation formulas are as follows:

$${L}_{quality - c} = - \frac{1}{\vert c \vert} {\sum }_{{x}_{c}^{i} ∈ C} log {p}_{c}^{i} , and$$

$${L}_{NER - c} = \frac{1}{{k}_{c}} {\sum }_{i = 0}^{{k}_{c}} {L}_{NER} ( {x}_{c}^{i} , {y}_{c}^{i} ) .$$

Each batch of expanded data samples Xₐ in the expanded data set A are inputted to the pretrained language model to acquire text representation of each sample xₐⁱ as [hₐ^{i,0}, . . . , hₐ^{i,j}, . . . hₐ^{i,n}]. Then, an intermediate representation after pooling is inputted into a quality discriminator MLP layer as an overall text representation, to obtain a score pₐⁱ of each sample. A calculation formula is as follows:

$${s}_{a}^{i} = tanh ( {W}_{p}^{T} {h}_{a}^{i , 0} + {b}_{p} ) ,$$

$${z}_{a}^{i} = {W}_{d}^{T} {s}_{c}^{i} + {b}_{q} , and$$

$${p}_{a}^{i} = \frac{1}{1 + {e}^{- {z}_{a}^{i}}} .$$

where a represents a quantity of expanded data samples in each batch in the expanded data set A, i represents a sequence number, xₐⁱ is an i^{th} sample in Xₐ, hₐ^{i,j} represents a (j+1)^{th} text representation of xₐⁱ, sₐⁱ is an intermediate representation after pooling of xₐⁱ, zₐⁱ is an implicit representation of sₐⁱ obtained by inputing an MLP, and pₐⁱ is a score of xₐⁱ, and Wₚ^{T}, bₚ, and b_{q} are preset parameters. It is assumed that a quantity of expanded samples in each batch is k. In each batch of training on the expanded data, scores of each sample are normalized, that is, a weight of high-quality data is highlighted in a current batch, a weight of low-quality data is reduced, and a training manner of normalizing equivalent weights of all samples in an original batch is adjusted. A weight of each sample is \hat{p}ₐⁱ, and a calculation formula is as follows:

$${\hat{p}}_{a}^{i} = \frac{{p}_{a}^{i}}{{\sum }_{{x}_{a}^{i} ∈ A} {p}_{a}^{i}} .$$

A loss function of an expanded sample xₐⁱ in the entity recognition task is L_{NER-a}, and a calculation formula is as follows:

$${L}_{NER - a} = {\sum }_{i = 0}^{{k}_{a}} {\hat{p}}_{a}^{i} \cdot {L}_{NER} ( {x}_{a}^{i} , {y}_{a}^{i} ) .$$

A clean subset C and an expanded data set A are integrated, an overall model training objective for each batch of data is a predicted loss value L, and a calculation formula is as follows:

$$L = {L}_{NER - c} + {L}_{NER - a} + α \cdot {L}_{quality - c} .$$

where α is a preset parameter, and is configured for adjusting an impact degree of the quality discriminator.

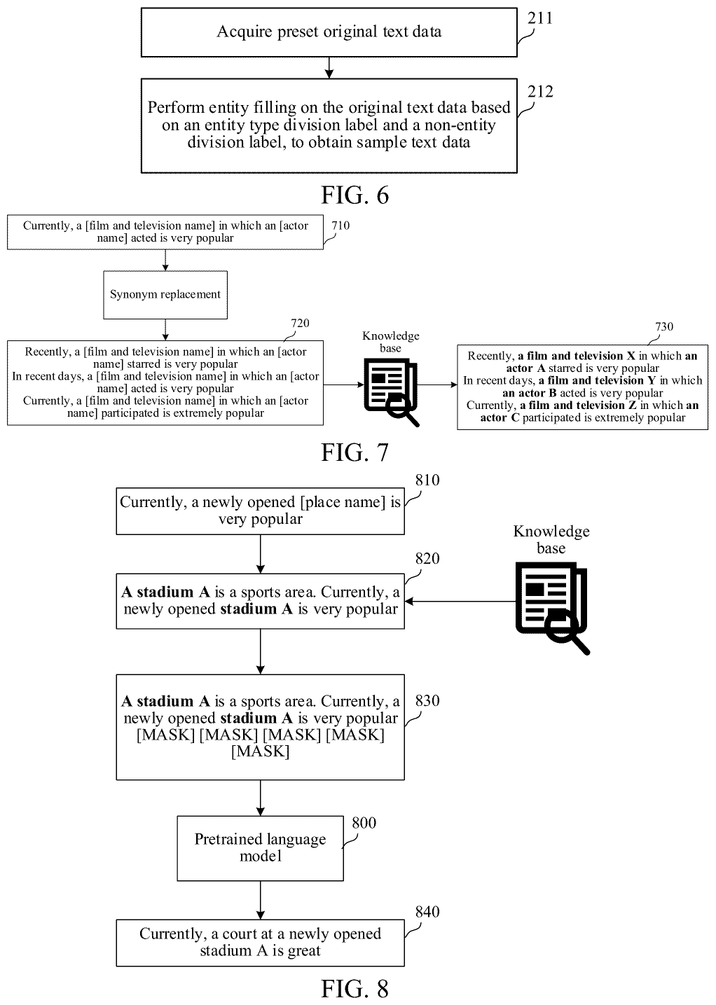

FIG. 6 is a flowchart of a method for acquiring sample text data according to an aspect of this disclosure. As shown in FIG. 6, in some aspects, the foregoing operation 210 includes the following operations.

Operation 211: Acquire preset original text data. For example, original text data including entity type content and non-entity text content is acquired. The original text data is labelled with an entity type division label and a non-entity division label to indicate distribution of the entity type content and the non-entity text content.

The original text data includes entity type content and non-entity text content, the original text data is labelled with an entity type division label and a non-entity division label, the entity type division label is configured for representing distribution of the entity type content in the original text data, and the non-entity division label is configured for representing distribution of the non-entity text content in the original text data.

In some aspects, the original text data is a sentence template including entity type content and non-entity text content, for example, “Currently, a newly opened [place name] is very popular”, and “Currently, a [film and television name] in which an [actor name] acted is very popular”, where the place name, the actor name, and the film and television name are the entity type content.

Operation 212: Perform entity filling on the original text data based on the entity type division label and the non-entity division label, to obtain the sample text data. For example, entity filling is performed on the original text data based on the entity type division label and the non-entity division label to obtain the sample text data.

In some aspects, the foregoing operation 212 is implemented as the following three operations.

Operation 1: Acquire entity filling content and non-entity filling content.

In some aspects, the entity filling content is entity text content that meets a semantic condition and that is retrieved in a specified knowledge base based on a semantic condition in the original text data, and the non-entity filling content is non-entity content that meets a near-synonymy relationship with the non-entity text content and that is retrieved based on a dictionary.

Operation 2: Replace the entity type content in the original text data with the entity filling content based on the entity type division label, to obtain first filling data.

For example, in the original text data “Currently, a newly opened [place name] is very popular”, the entity type content “place name” is replaced with the entity filling content “restaurant A” based on the entity type division label, to obtain the first filling data “Currently, a newly opened restaurant A is very popular”.

Operation 3: Replace the non-entity text content in the first filling data with the non-entity filling content based on the non-entity division label, to obtain the sample text data.

For example, in the first filling data “Currently, a newly opened restaurant A is very popular”, the non-entity text content “very popular” is replaced with the non-entity filling content “extremely popular” based on the non-entity division label, to obtain the sample text data “Currently, a newly opened restaurant A is extremely popular”.

The foregoing operation 211 and operation 212 describe content of performing entity filling on the original text data based on different labels to obtain the sample text data. After the original text data is determined, the entity type content and the non-entity text content included in the original text data are determined. Distribution of the entity type content is represented by the entity type division label, and distribution of the non-entity text content is represented by the non-entity division label, so that a filling template is provided for a subsequent entity filling process through the entity type division label and the non-entity division label corresponding to the original text data, which facilitates more targeted entity filling based on different labels, thereby obtaining more sample text data through expansion based on the original text data, and improving a scale of acquiring the sample text data. In this way, a more robust model training process is subsequently performed by using more sample text data.

In summary, according to the method provided in the aspects of this disclosure, the preset original text data is acquired, and the entity filling is performed on the original text data based on the entity type division label and the non-entity division label, to obtain the sample text data. A method for acquiring the sample text data is provided, thereby implementing data expansion.

According to the method provided in the aspects of this disclosure, the entity filling content and the non-entity filling content are acquired, the entity type content in the original text data is replaced with the entity filling content based on the entity type label, to obtain the first filling data, and the non-entity text content in the first filling data is replaced with the non-entity filling content based on the non-entity division label, so that a plurality of pieces of sample text data with similar representation meanings and more diversified representation forms are obtained through replacement of the entity type content and/or replacement of the non-entity text content, to achieve an objective of acquiring more sample text data based on an entity filling method for the original text data. The quantity of data expansion is ensured when a quantity of sample text data is increased.

In some aspects, the foregoing method of acquiring the sample text data is implemented as a data expansion process. In some aspects, the data expansion process includes three data expansion manners: dictionary-based expansion, text prompt-based pretrained language model expansion, and multi-model recall-based expansion. Next, the three data expansion manners are described.

### 1. Dictionary-Based Expansion

In some aspects, data expansion is performed based on dictionary expansion, that is, by using a synonym dictionary and an entity word dictionary. For a given annotated data, a text is divided into a word sequence through word segmentation on a non-entity word, and a part in the sequence is selected to replace the non-entity word in various manners through the synonym dictionary, to expand an annotation template, and then the annotation template is filled through an entity word knowledge base, to generate expanded data.

For example, FIG. 7 is a schematic diagram of dictionary-based data expansion according to an aspect of this disclosure. As shown in FIG. 7, a non-entity word in a sentence template 710 is replaced with synonyms based on a synonym dictionary, to obtain a newly added template 720. In other words, a non-entity word in “Currently, a [film and television name] in which an [actor name] acted is very popular” is replaced with synonyms in various manners, to obtain “Recently, a [film and television name] in which an [actor name] starred is very popular”, “In recent days, a [film and television name] in which an [actor name] acted is very popular”, and “Currently, a [film and television name] in which an [actor name] participated is extremely popular”. Based on an entity type labelled in the newly added template 720, a combination relationship between the actor name and the film and television name in a corresponding film and television field is queried, and the newly added template 720 is filled with the entity word that meets the combination relationship in the entity word knowledge base, to obtain expanded data 730, that is, “Currently, a film and television X in which an actor A acted is very popular”, “In recent days, a film and television Y in which an actor B acted is very popular”, and “Currently, a film and television Z in which an actor C participated is extremely popular”.

### 2. Text Prompt-Based Pretrained Language Model Expansion

In some aspects, a hollow position in a text is filled by using the pretrained language model. The pretrained language model has excellent performance in language modeling through a pretraining task with large amounts of data. Therefore, higher-quality expanded data may be generated by using the pretrained model. In addition, a text prompt about a current entity word is spliced on the input of the pretrained language model, and an expansion template based on dictionary expansion and an operation of filling the entity word are merged. When the sentence template is expanded, more proper expanded data is generated by combining a semantic representation and an entity category of the current entity word. For a given annotated text, an opposite annotated template is constructed. For an entity slot in the template, a related entity word is extracted in various manners from a knowledge base, the text is filled, and a corresponding text prompt is generated. A non-entity word part is hollowed out in various manners and filled with a mask of a random length, and the mask is inputted into the pretrained language model. The model fills a mask position with reference to the text prompt and the text, to generate an expanded sample. The expanded sample context generated based on this is strongly correlated with the entity word, which alleviates a problem of context conflict caused by replacing synonyms in various manners in dictionary-based expansion, and is more appropriate to a real text scenario.

For example, FIG. 8 is a schematic diagram of text prompt-based pretrained language model data expansion according to an aspect of this disclosure. As shown in FIG. 8, a text prompt 820 is acquired from a knowledge base based on semantic information about an original text 810, that is, a text prompt “A stadium A is a sports area” about a current entity word is acquired based on “Currently, a newly opened [place name] is very popular. Currently, a newly opened stadium A is very popular”. The text prompt 820 is hollowed out in various manners to obtain template text 830, that is, “The stadium A is a sports area. “Currently, a newly opened stadium A [MASK] [MASK] [MASK] [MASK] [MASK]”, the template text 830 is inputted into the pretrained language model 800, and an expanded text 840 is outputted, that is, “Currently, a court at a newly opened stadium A is great”.

### 3. Multi-Model Recall-Based Expansion

In some aspects, data is recalled from unsupervised data by using a trained named entity recognition (NER) model, and text in which an entity is recognized is recorded as a possible positive sample. However, this may lead to the introduction of mistaken data, and direct training may reduce accuracy of the model. In addition, distribution of entities that can be recognized by a single model is limited, and data recalled by only the single model is biased, which is not conducive to continuing to training the model. Therefore, in the aspects of this disclosure, entity word disambiguation is first performed through a form retrieved by the knowledge base, to filter out as part of mistaken entities as possible. Then, coverage is expanded based on multi-model and multi-way recall. Alternatively, data amplification is performed by using distribution of high-confidence data based on multi-way recall, and manual verification is performed on a low-confidence part and then further expansion is performed, so that a training effect on a model boundary sample is continuously improved.

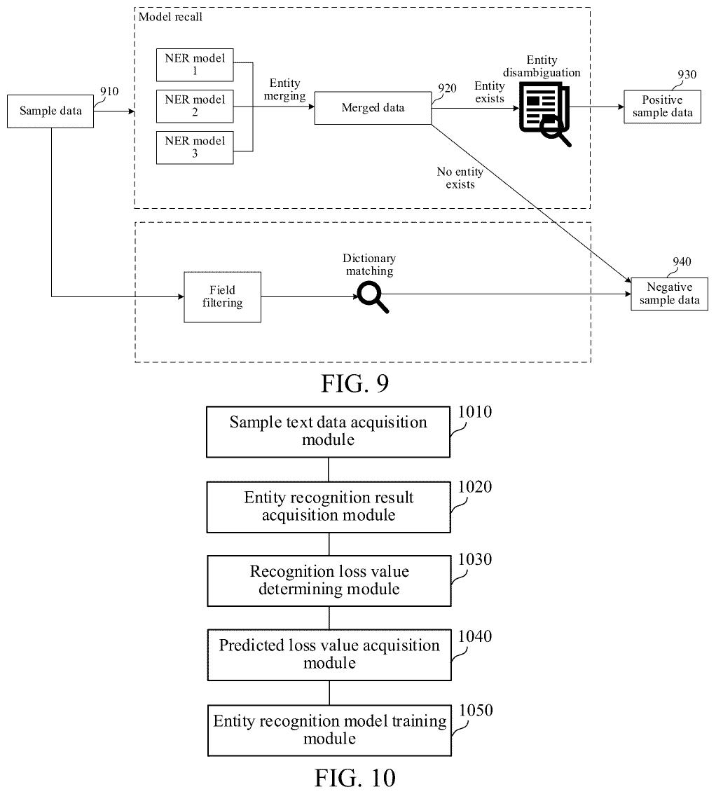

For example, FIG. 9 is a schematic diagram of multi-model recall-based data expansion according to an aspect of this disclosure. As shown in FIG. 9, model recall is performed based on sample data 910, entities are merged on recall data of a plurality of NER models, to obtain merged data 920. If the merged data 920 has an entity word, entity disambiguation is performed on the merged data 920, to obtain expanded positive sample data 930. If the merged data 920 has no entity word, the merged data 920 is used as expanded negative sample data 940. Domain filtering is performed based on the sample data 910, to obtain the expanded negative sample data 940.

FIG. 10 is a structural block diagram of an apparatus for training an entity recognition model according to an aspect of this disclosure. As shown in FIG. 10, the apparatus includes the following parts:

a sample text data acquisition module 1010, configured to acquire sample text data, the sample text data including entity text content, the sample text data being labeled with an entity division label, and the entity division label being configured for representing distribution of the entity text content in the sample text data;

an entity recognition result acquisition module 1020, configured to perform entity recognition on the sample text data by using a candidate entity recognition model, to obtain an entity recognition result corresponding to the sample text data;

a recognition loss value determining module 1030, configured to determine a recognition loss value based on a difference between the entity division label and the entity recognition result;

a predicted loss value acquisition module 1040, configured to acquire a sample quality score corresponding to the sample text data, and perform loss adjustment on the recognition loss value based on the sample quality score, to obtain a predicted loss value, the sample quality score being configured for representing a loss weight corresponding to the recognition loss value; and

an entity recognition model training module 1050, configured to train the candidate entity recognition model based on the predicted loss value, to obtain an entity recognition model, the entity recognition model being configured for performing entity recognition on inputted text data.

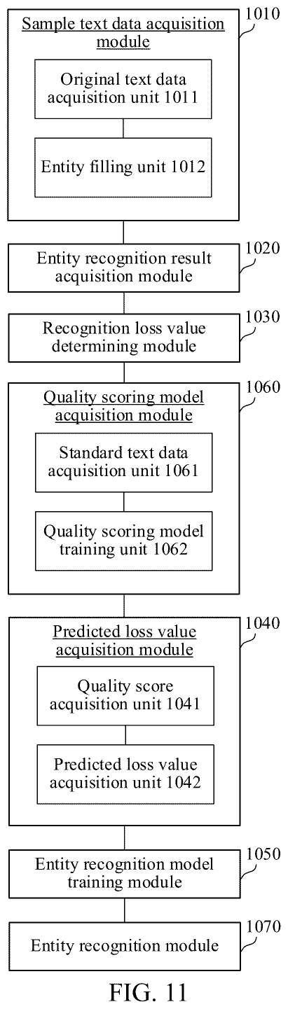

FIG. 11 is a structural block diagram of an apparatus module for training an entity recognition model according to an aspect of this disclosure. As shown in FIG. 11, in some aspects, the predicted loss value acquisition module 1040 includes:

a quality score acquisition unit 1041, configured to perform quality scoring on the sample text data by using a quality scoring model, to obtain the sample quality score, the quality scoring model being a pretrained model, and the quality scoring model being configured to perform quality scoring on inputted text data; and

a predicted loss value acquisition unit 1042, configured to perform loss adjustment on the recognition loss value based on the sample quality score, to obtain the predicted loss value.

In some aspects, the predicted loss value acquisition unit 1042 is configured to: determine a loss weight corresponding to the recognition loss value based on the sample quality score; and fuse the loss weight and the recognition loss value to obtain the predicted loss value.

In some aspects, the apparatus further includes a quality scoring model acquisition module 1060. The quality scoring model acquisition module 1060 includes:

a reference text data acquisition unit 1061, configured to acquire preset reference text data, the reference text data being labelled with a reference score label, and the reference score label being configured for representing a quality score corresponding to the reference text data; and

a quality scoring model training unit 1062, configured to train a candidate quality scoring model based on the reference text data, to obtain the quality scoring model.

In some aspects, the quality scoring model training unit 1062 is configured to: perform quality scoring on the reference text data by using the candidate quality scoring model, to obtain a standard quality score corresponding to the reference text data; determine a quality score loss value based on a difference between the standard quality score and the reference score label; and train the candidate quality scoring model based on the quality score loss value to obtain the quality scoring model.

In some aspects, the entity recognition model training module 1050 is configured to: train the candidate entity recognition model based on the predicted loss value until the predicted loss values converge, to obtain the entity recognition model; or train the candidate entity recognition model based on the predicted loss value until the predicted loss value reaches a specified threshold, to obtain the entity recognition model.

In some aspects, the sample text data acquisition module 1010 includes:

an original text data acquisition unit 1011, configured to acquire preset original text data, the original text data including entity type content and non-entity text content, the original text data being labelled with an entity type division label and a non-entity division label, the entity type division label being configured for representing distribution of the entity type content in the original text data, and the non-entity division label being configured for representing distribution of the non-entity text content in the original text data; and

an entity filling unit 1012, configured to perform entity filling on the original text data based on the entity type division label and the non-entity division label, to obtain the sample text data.

In some aspects, the entity filling unit 1012 is configured to: acquire entity filling content and non-entity filling content; replace the entity type content in the original text data with the entity filling content based on the entity type division label, to obtain first filling data; and replace the non-entity text content in the first filling data with the non-entity filling content based on the non-entity division label, to obtain the sample text data.

In some aspects, the apparatus further includes an entity recognition module 1070. The entity recognition module 1070 is configured to: acquire text data; and input the text data into the entity recognition model for entity recognition, to output a corresponding entity recognition prediction result, the entity recognition prediction result being configured for representing distribution of entity text content in the text data.

In summary, in the apparatus provided in the aspects of this disclosure, entity recognition is performed on the acquired sample text data by using the candidate entity recognition model, to obtain the entity recognition result corresponding to the sample text data, the recognition loss value is determined based on the difference between the entity division label and the entity recognition result, the sample quality score corresponding to the sample text data is acquired, loss adjustment is performed on the recognition loss value based on the sample quality score, to obtain the predicted loss value, and the candidate entity recognition model is trained by using the adjusted predicted loss value, to obtain the entity recognition model. In addition, when noise data is not introduced into sample text data obtained through additional labeling, a loss weight corresponding to the recognition loss value is learned based on the sample quality score determined for the sample text data, so that differential loss adjustment is performed on the candidate entity recognition model based on recognition loss values respectively corresponding to sample text data with different sample quality scores. In this way, limited sample text data that has been labeled can be fully used to more robustly train the candidate entity recognition model, thereby greatly reducing impact of the noise data on the entity recognition result, and improving efficiency of training the entity recognition model and accuracy of entity recognition.

The apparatus for training an entity recognition model provided in the foregoing aspects is merely illustrated with an example of division of functional modules. In actual application, the functions may be allocated and completed by different functional modules according to requirements, that is, an internal structure of the device is divided into different functional modules, to implement all or some of the functions described above.

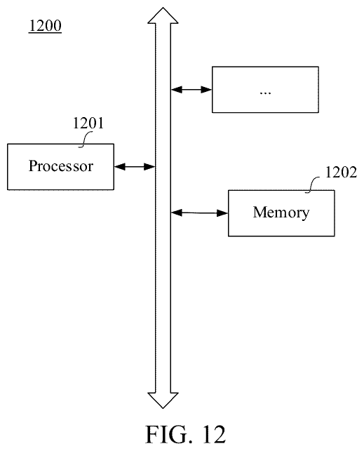

FIG. 12 is a structural block diagram of a terminal 1200 according to an aspect of this disclosure. The terminal 1200 may be: a smartphone, a tablet computer, a Moving Picture Experts Group Audio Layer III (MP3) player, a Moving Picture Experts Group Audio Layer IV (MP4) player, a notebook computer, or a desktop computer. The terminal 1200 may also be referred to as other names such as user equipment, a portable terminal, a laptop terminal, or a desktop terminal.

The terminal 1200 includes: a processor 1201 (e.g., processing circuitry) and a memory 1202 (e.g., a non-transitory computer-readable storage medium).

The processor 1201 may include one or more processing cores, such as a 4-core processor or an 8-core processor. The processor 1201 may be implemented by using at least one hardware form of a digital signal processing (DSP), a field-programmable gate array (FPGA), and a programmable logic array (PLA). The memory 1202 may include one or more computer-readable storage media. The computer-readable storage media may be non-transitory.

In some aspects, the terminal 1200 further include another component. A person skilled in the art may understand that the structure shown in FIG. 12 does not constitute a limitation to the terminal 1200, and the terminal 1200 may include more or fewer components than those shown in the figure, or some components may be combined, or a different component deployment may be used.

An aspect of this disclosure further provides a computer device. The computer device may be implemented as the terminal or the server shown in FIG. 1. The computer device includes a processor and a memory. The memory has at least one instruction, at least one program, a code set, or an instruction set stored therein, the at least one instruction, the at least one program, the code set, or the instruction set being loaded and executed by the processor to implement the method for training an entity recognition model according to the foregoing method aspects.

An aspect of this disclosure further provides a computer-readable storage medium. The computer-readable storage medium has at least one instruction, at least one program, a code set, or an instruction set stored therein, the at least one instruction, the at least one program, the code set, or the instruction set being loaded and executed by the processor to implement the method for training an entity recognition model according to the foregoing method aspects.

An aspect of this disclosure further provides a computer program product or a computer program. The computer program product or the computer program includes computer instructions, the computer instructions being stored in a computer-readable storage medium such as a non-transitory computer-readable storage medium. A processor of a computer device reads the computer instructions from the computer-readable storage medium, and executes the computer instructions, to cause the computer device to perform the method for training an entity recognition model according to any one of the foregoing aspects.

In some aspects, the computer-readable storage medium may include: a read only memory (ROM), a random access memory (RAM), a solid state drive (SSD), an optical disc, or the like. The RAM may include a resistance random access memory (ReRAM) and a dynamic random access memory (DRAM). The sequence numbers of the foregoing aspects of this disclosure are merely for description purpose, and do not indicate the preference of the aspects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

What is claimed is:

1. A method for training an entity recognition model, the method comprising:
acquiring sample text data including entity text content, the sample text data being labelled with an entity division label that represents a distribution of the entity text content in the sample text data;
performing entity recognition on the sample text data using a candidate entity recognition model to obtain an entity recognition result corresponding to the sample text data;
determining a recognition loss value based on a difference between the entity division label and the entity recognition result;
acquiring a sample quality score corresponding to the sample text data, the sample quality score representing a loss weight that corresponds to the recognition loss value;
performing loss adjustment on the recognition loss value based on the sample quality score to obtain a predicted loss value; and
training the candidate entity recognition model based on the predicted loss value to obtain a trained entity recognition model that is configured to perform entity recognition on inputted text data.

2. The method according to claim 1, wherein the acquiring the sample quality score comprises:
performing quality scoring on the sample text data using a quality scoring model to obtain the sample quality score, the quality scoring model being configured to perform quality scoring on inputted text data.

3. The method according to claim 2, further comprising:
acquiring reference text data labelled with a reference score label, the reference score label representing a quality score that corresponds to the reference text data; and
training a candidate quality scoring model based on the reference text data to obtain the quality scoring model.

4. The method according to claim 3, wherein the training the candidate quality scoring model comprises:
performing quality scoring on the reference text data using the candidate quality scoring model to obtain a reference quality score corresponding to the reference text data;
determining a quality score loss value based on a difference between the reference quality score and the reference score label; and
training the candidate quality scoring model based on the quality score loss value to obtain the quality scoring model.

5. The method according to claim 1, further comprising:
determining a loss weight corresponding to the recognition loss value based on the sample quality score; and
combining the loss weight and the recognition loss value to obtain the predicted loss value.

6. The method according to claim 1, wherein the training the candidate entity recognition model based on the predicted loss value, comprises:
iteratively training the candidate entity recognition model based on the predicted loss value until the predicted loss value converges or reaches a specified threshold.

7. The method according to claim 1, wherein the acquiring the sample text data comprises:
acquiring original text data including entity type content and non-entity text content, the original text data being labelled with an entity type division label and a non-entity division label to indicate distribution of the entity type content and the non-entity text content; and
performing entity filling on the original text data based on the entity type division label and the non-entity division label to obtain the sample text data.

8. The method according to claim 7, wherein the performing the entity filling comprises:
acquiring entity filling content and non-entity filling content;
replacing the entity type content in the original text data with the entity filling content based on the entity type division label to obtain first filling data; and
replacing the non-entity text content in the first filling data with the non-entity filling content based on the non-entity division label to obtain the sample text data.

9. The method according to claim 1, further comprising:
acquiring text data;
inputting the text data into the trained entity recognition model for entity recognition; and
receiving, from the trained entity recognition model, an entity recognition prediction result indicating a distribution of entity text content in the text data.

10. An information processing apparatus, comprising:
processing circuitry configured to:
acquire sample text data including entity text content, the sample text data being labelled with an entity division label that represents a distribution of the entity text content in the sample text data;
perform entity recognition on the sample text data using a candidate entity recognition model to obtain an entity recognition result corresponding to the sample text data;
determine a recognition loss value based on a difference between the entity division label and the entity recognition result;
acquire a sample quality score corresponding to the sample text data, the sample quality score representing a loss weight that corresponds to the recognition loss value;
perform loss adjustment on the recognition loss value based on the sample quality score to obtain a predicted loss value; and
train the candidate entity recognition model based on the predicted loss value to obtain a trained entity recognition model that is configured to perform entity recognition on inputted text data.

11. The information processing apparatus according to claim 10, wherein the processing circuitry is configured to:
perform quality scoring on the sample text data using a quality scoring model to obtain the sample quality score, the quality scoring model being configured to perform quality scoring on inputted text data.

12. The information processing apparatus according to claim 11, wherein the processing circuitry is configured to:
acquire reference text data labelled with a reference score label, the reference score label representing a quality score that corresponds to the reference text data; and
train a candidate quality scoring model based on the reference text data to obtain the quality scoring model.

13. The information processing apparatus according to claim 12, wherein the processing circuitry is configured to:
perform quality scoring on the reference text data using the candidate quality scoring model to obtain a reference quality score corresponding to the reference text data;
determine a quality score loss value based on a difference between the reference quality score and the reference score label; and
train the candidate quality scoring model based on the quality score loss value to obtain the quality scoring model.

14. The information processing apparatus according to claim 10, wherein the processing circuitry is configured to:
determine a loss weight corresponding to the recognition loss value based on the sample quality score; and
combine the loss weight and the recognition loss value to obtain the predicted loss value.

15. The information processing apparatus according to claim 10, wherein the processing circuitry is configured to:
iteratively train the candidate entity recognition model based on the predicted loss value until the predicted loss value converges or reaches a specified threshold.

16. The information processing apparatus according to claim 10, wherein the processing circuitry is configured to:
acquire original text data including entity type content and non-entity text content, the original text data being labelled with an entity type division label and a non-entity division label to indicate distribution of the entity type content and the non-entity text content; and
perform entity filling on the original text data based on the entity type division label and the non-entity division label to obtain the sample text data.

17. The information processing apparatus according to claim 16, wherein the processing circuitry is configured to:
acquire entity filling content and non-entity filling content;
replace the entity type content in the original text data with the entity filling content based on the entity type division label to obtain first filling data; and
replace the non-entity text content in the first filling data with the non-entity filling content based on the non-entity division label to obtain the sample text data.

18. The information processing apparatus according to claim 10, wherein the processing circuitry is configured to:
acquire text data;
input the text data into the trained entity recognition model for entity recognition; and
receive, from the trained entity recognition model, an entity recognition prediction result indicating a distribution of entity text content in the text data.

19. A non-transitory computer-readable storage medium storing instructions which, when executed by a processor, cause the processor to perform:
acquiring sample text data including entity text content, the sample text data being labelled with an entity division label that represents a distribution of the entity text content in the sample text data;
performing entity recognition on the sample text data using a candidate entity recognition model to obtain an entity recognition result corresponding to the sample text data;
determining a recognition loss value based on a difference between the entity division label and the entity recognition result;
acquiring a sample quality score corresponding to the sample text data, the sample quality score representing a loss weight that corresponds to the recognition loss value;
performing loss adjustment on the recognition loss value based on the sample quality score to obtain a predicted loss value; and
training the candidate entity recognition model based on the predicted loss value to obtain a trained entity recognition model that is configured to perform entity recognition on inputted text data.

20. The non-transitory computer-readable storage medium according to claim 19, wherein the acquiring the sample quality score comprises:
performing quality scoring on the sample text data using a quality scoring model to obtain the sample quality score, the quality scoring model being configured to perform quality scoring on inputted text data.
